(19) United States
(12) Patent Application Publication
(10) Pub. No.: US 2022/0019975 A1
(43) Pub. Date: Jan. 20, 2022

(54) METHODS AND SYSTEMS FOR PROVIDING AUTHENTICATED FIDUCIARIES WITH ACCESS TO SECURED DIGITAL ASSETS

(71) Applicant: The Digital Asset Initiative Association, Beaver, PA (US)

(72) Inventor: Tod R. Arbutina, Beaver, PA (US)

(21) Appl. No.: 16/932,293

(22) Filed: Jul. 17, 2020

(51) Int. Cl. G06Q 10/10; G06F 21/62; H04L 29/06

(52) U.S. Cl. CPC G06Q 10/1053; H04L 63/08; G06F 21/6218

(57) ABSTRACT

Methods and systems for authenticating fiduciary users before providing access to secured assets are disclosed. These methods and systems operate to provide access to a variety of different fiduciaries and provides for flexibility to specify varying types of validation and credentialing depending on the industry and licensing authority for the fiduciary. Fiduciary users may be authenticated via a variety of authentication methods which vary depending on the type of fiduciary user. If an authentication method returns a positive authentication result, a verification token is associated with the fiduciary user file to represent successful verification of the fiduciary via the associated authentication process.

### FIELD

The field of this disclosure relates to data security, and specifically, to methods and systems for authenticating fiduciaries before providing them access to secured digital assets.

### BACKGROUND

An individual has numerous interactions with fiduciaries. Each interaction often requires access to personal information of the individual so that the fiduciary can provide the services required of the relationship. For example, people hire accountants to provide financial assistance, business bookkeeping, and prepare tax returns. People rely upon attorneys to perform estate services, resolve family law matters, and advise and counsel them in a range of matters. People also rely upon professionals who manage their investments. Hospitals and doctors also have fiduciary relationship responsibilities.

In the digital age, many individuals struggle with providing personal information electronically while ensuring that only their chosen fiduciary accesses the information. There are often reports of breaches or losses of personal data at large companies. These reports create in people a reluctance to share personal information and a concern that shared personal information will be kept secure. People bring this reluctance and concern with them in their interactions with fiduciaries. Furthermore, fiduciaries owe a duty to their clients whereby the fiduciary must act in good faith and the best interests of the clients, including protecting personal information, documents, and materials. Therefore, there is a need in the art for providing a method and system for allowing fiduciaries to securely access personal digital assets in a manner that continually or regularly positively confirms the identity of the accessor to be that of the chosen fiduciary. Further, there is also a need to audit the actions of a fiduciary to ensure the fiduciary is keeping a client's digital assets and personal information secure.

### SUMMARY

One aspect of this disclosure provides a computer-implemented method for providing a fiduciary with a digital token configured to allow access to a secured digital asset. The method comprising the steps of: receiving, at a server operably connected to a network, an application comprising information that identifies an applicant and indicates the applicant's profession; receiving, at the server, professional license information of the applicant; creating, at the server, a file for the applicant; searching an online database comprising licensure information of practitioners of the profession of the applicant; locating licensure information of the applicant in the database; verifying that the applicant's professional license is valid; adding the applicant to a fiduciary database connected to the server, wherein the fiduciary database comprises a plurality of names of individuals that have been verified as having a valid professional license; and adding a digital token to the file of the applicant, wherein the digital token is configured to allow access to a digital asset stored in a digital vault.

In some embodiments, the method further comprises providing to the applicant, over a network, a curriculum; and certifying that the curriculum has been sent to the applicant. In certain embodiments, the method also comprises administering an on-line examination to the applicant, wherein the examination comprises questions related to the curriculum; and certifying that a predetermined percentage of the answers received from the applicant are correct. In still other embodiments, the curriculum comprises material related to practices for protecting digital assets. In some embodiments, the curriculum comprises material related to ethics or rules of professional responsibility related to the profession of the applicant.

In some embodiments, the method also comprises receiving, at the server, an agreement from the applicant indicating the applicant's assent to the application process. In certain embodiments, the method comprises receiving, at the server, an attestation from the applicant, wherein the attestation indicates that the applicant agrees to terms of service associated with use of the digital token.

In further embodiments, the method comprises performing an online background check of the applicant. In some embodiments, the background check comprises searching for information related to one or more of the applicant's criminal background, credit score, bankruptcy history, professional license history, aliases, education history, or combinations thereof.

In some embodiments, the method comprises notifying the applicant that the applicant has been granted a digital token.

Another aspect of this disclosure provides a computer-implemented method for credentialing a fiduciary to allow the fiduciary to access one or more digital assets stored in a vault, the method comprising. The method for credentialing a fiduciary comprises receiving, at a server operably connected to a network, an application comprising information that identifies an applicant and indicates the applicant's profession; receiving, at the server, professional license information of the applicant; creating, at the server, a file for the applicant; searching an online database comprising licensure information of practitioners of the profession of the applicant; locating licensure information of the applicant in the database; verifying that the applicant's professional license is valid; and issuing a credential to the fiduciary, whereby the credential allows the fiduciary to access to one or more digital assets stored in a digital vault. In some embodiments, the credential is a digital token. In some embodiments, the credential is a seal or certificate that indicates the fiduciary has been credentialed. In some embodiments, the professional license is an accountancy license. In some embodiments, the professional license is a license to practice law.

Another aspect of this disclosure provides a system configured to grant to an authenticated fiduciary access to one or more digital assets stored in a digital vault, the method comprising. The system comprises a server operably connected to a network and configured to process applications for authentication. The system also comprises a memory module configured to store information of an application of a fiduciary and professional licensure information of the fiduciary, wherein the application requests authentication. In some embodiments, the application of the fiduciary comprises identifying information. The system also comprises a verification module configured to determine the status of a professional license of the fiduciary. In some embodiments, the verification module searches an online database comprising information related to the licensure of professionals in a certain profession. The verification module determines whether the fiduciary's professional license is valid, suspended, revoked, or if it has any other status.

In some embodiments, the system also comprises a background check module configured to perform research into the background of the fiduciary. In some embodiments, the background check module can conduct research into one or more of the fiduciary's criminal background, bankruptcy history, credit score, employment history, education history, or a combination thereof. The background check module, in some embodiments, can also be configured to communicate with a third party to conduct the background check.

In some embodiments, the system also comprises an education module configured to send a curriculum to the fiduciary applicant, wherein the curriculum is configured to be viewed on a screen. The curriculum can be sent to the fiduciary over the network or via email or text, or through a digital server. In some embodiments, the curriculum comprises material related to practices for accessing digital assets and protecting digital assets.

The system also comprises a fiduciary user database configured to store a file of an authenticated fiduciary and a digital token associated with the authenticated fiduciary. Once a fiduciary is included in the fiduciary user database, the fiduciary has been authenticated by the system.

The system also comprises a processor module configured to add the fiduciary to the fiduciary user database and to associate a digital token with the fiduciary when the verification module, the background check module, the education module, or a combination thereof submit confirmation of authentication to the processor. The digital token is configured to allow the authenticated fiduciary to access one or more digital assets stored in a digital vault. In some embodiments, the confirmation of authentication can occur when the verification module confirms that validity of the fiduciary's professional license. In some embodiments, the confirmation of authentication can occur when the background check module confirms that the fiduciary does not have any pre-set background issues that would prevent authentication. For example, if the fiduciary has an arrest record, or conviction record, or bankruptcy history, or a credit score below a threshold, the background check module, in some embodiments, returns a “failed” status instead of an authenticated status. In some embodiments, the education module can confirm authentication after the education module has sent the curriculum to the fiduciary. In some embodiments, the education module confirms authentication upon receiving confirmation from the fiduciary that the fiduciary has reviewed the curriculum. In further embodiments, the education module is configured to conduct an examination of the fiduciary to determine whether the fiduciary retains a minimum level of knowledge about the curriculum.

In the system, the server, verification module, background check module, education module, fiduciary user database, and processor module are communicatively coupled.

In another aspect, the disclosure provides a computer-implemented method for providing a fiduciary with access to a secured digital asset, the method comprising the steps of: validating a fiduciary, validating comprising confirming the identity of the fiduciary using information submitted by the fiduciary; verifying a fiduciary, comprising one or more of conducting a background check, verifying professional licensure, running a credit check, or a combination thereof; associating a digital token with a user profile associated with the fiduciary, wherein the digital token is configured to allow access to a digital assets stored in a digital vault.

One aspect of this disclosure provides a method for providing authenticated fiduciaries with access to secured digital assets, the method comprising the steps of validating a fiduciary applicant, verifying a fiduciary applicant, associating a token with a user profile associated with the fiduciary applicant, and granting access to secured digital assets to a fiduciary applicant. The validating step may comprise the following steps: receiving validation information from the fiduciary applicant; providing instructions to the fiduciary applicant; and requesting validation from the fiduciary applicant. The verifying step may comprise the following steps: receiving applicant information from the fiduciary applicant; receiving professional documents from the fiduciary applicant; and executing a verification search regarding the fiduciary applicant. Furthermore, the associating step may further comprise adding the fiduciary applicant to a user database.

In yet another aspect, the disclosure provides a method for providing authenticated fiduciaries with access to secured digital assets, the method comprising the steps of determining if a user has SDAFV status; granting rights to an administrator based on a specified purpose and SDAFV status; and maintaining the rights based on preset criteria. The granting rights step comprises granting fiduciary purpose rights, non-fiduciary purpose rights, fiduciary corporate purpose rights, and non-corporate purpose rights.

The disclosure also provides a system for providing authenticated fiduciaries with access to secured assets, the system comprising one or more sanctuary individual vaults; a memory module; a user database; wherein the one or more sanctuary individual vaults, memory module, and user database are communicatively coupled to each other, and a processor module, wherein the processor module comprises instructions operative to perform the following steps: validating a fiduciary applicant; verifying a fiduciary applicant; associating a token with a user profile associated with the fiduciary applicant; and granting access to secured assets to a fiduciary applicant.

The system may further comprise an education module, a background check module, and a validation module. The validation module is configured to receive instructions from the processor module operative to perform the following steps: receiving validation information from the fiduciary applicant; providing instructions to the fiduciary applicant; and requesting validation from the fiduciary applicant.

Another embodiment of the system for providing authenticated fiduciaries with access to secured digital assets is described, the system comprises: one or more digital vaults; a memory module; and a user database; wherein the one or more individual digital vaults, memory module, and user database are communicatively coupled to each other, and a processor module, wherein the processor module comprises instructions operative to perform the following steps: determining if a user has SDAFV status; granting rights to an administrator based on a specified purpose and SDAFV status; and maintaining the rights based on preset criteria. The maintaining step performed by the processor module may further comprise checking credentialing of a user via a validation process.

### BRIEF DESCRIPTION OF THE FIGURES

These and other features and advantages of this disclosure will be better understood by reading the following detailed description, taken together with the drawings wherein like numerals correspond to like elements or steps throughout the several views.

FIG. 1 is system diagram illustrating the Sanctuary fiduciary authentication system in accordance with an embodiment of this disclosure.

FIG. 2 is a system diagram illustrating the DAI digital-asset fiduciary authentication system in accordance with an embodiment of this disclosure.

FIG. 3 is a flow diagram illustrating the Sanctuary validation process in accordance with an embodiment of this disclosure.

FIG. 4 is a flow diagram illustrating the DAI verification and credential process in accordance with an embodiment of this disclosure.

FIG. 5 is a block diagram illustrating the various purposes that may be accommodated by the Sanctuary Administrator 120 within the Sanctuary fiduciary authentication system 100.

### DETAILED DESCRIPTION

This disclosure provides methods and systems for authenticating a fiduciary user before providing the fiduciary user with access to secured digital assets. Digital assets include, for example, documents comprising personal information, medical records, tax documents, tax returns, estate planning documents, wills, trusts, documents protected by the attorney-client privilege, documents protected by other recognized privileges, correspondence between an individual and a doctor, bank records, financial statements, financial materials prepared by financial professionals, confidential agreements, and other materials that are not generally available to the public. An example of a system for authenticating a fiduciary is the Sanctuary fiduciary authentication system which is aligned with the mission of Digital-Asset Initiative (“DAI”). The DAI digital-asset fiduciary authentication system, in one embodiment, is used in combination with the Sanctuary fiduciary authentication system. The DAI digital-asset fiduciary authentication system, also referred to as the DAI digital-asset fiduciary authentication server, operates to provide access to secured assets to a variety of different fiduciaries, including companies with fiduciary responsibilities, and provides for flexibility to specify varying types of verification and credentialing depending on the industry and licensing authority for the fiduciary prior to granting access. The DAI digital-asset fiduciary authentication system is focused on credentials for a Digital-Asset Fiduciary (DAF). In an embodiment of the Sanctuary fiduciary authentication system, the credentials may be Sanctuary Digital-Asset Fiduciary (“SDAF”) and Sanctuary Digital-Asset Fiduciary Validator (“SDAFV”).

In the systems and methods of this disclosure, fiduciary users originate as fiduciary applicants and are converted to fiduciary users via a variety of authentication methods including without limitation a verification process. For purposes of this disclosure, the term “user” may refer to a fiduciary applicant, a fiduciary user, or a non-fiduciary user depending on the context. As used herein, the articles “a” or “an” mean one or more unless these terms are otherwise limited by the context of their use. The specific methods of authentication, the steps involved, and combination of authentication methods for converting a fiduciary applicant to a fiduciary user vary depending on the type of fiduciary relationship. For example, if the fiduciary is an accountant, the authentication method may comprise checking the State Board of Accountancy in the state which the alleged accountant proports to be licensed. If the fiduciary is an attorney, the authentication method may comprise a check of the state bar website which licensed the attorney to ensure that the attorney's name is included in the list of licensed practitioners. In some embodiments, if the authentication method or combination of authentication methods return with a positive authentication result, a verification token is associated with the fiduciary user file to represent successful verification of the fiduciary via the associated fiduciary authentication method.

In addition, this disclosure provides various DAI digital-asset fiduciary authentication systems and methods for verifying a fiduciary applicant via specific information which depends on the type of fiduciary applicant and the type of fiduciary relationship. In one embodiment, the specific information may comprise a social security number, a personal identification number, or a self-attestation statement regarding identity or intended purposes for using the fiduciary authentication system, or a combination thereof. In some embodiments, additional specific information includes a phone number, address or addresses, social security number, date of birth, Real ID, driver's license number, passport number, or a combination thereof. As part of the verification process, in one embodiment, instructions may be provided to the fiduciary applicant based on the type of environment housing the fiduciary authentication system. In some embodiments, these instructions contain statements regarding requirements for encryption, document retention rules, or other policies regarding the handling of sensitive information. After authenticating methods are completed with positive authentication tokens, then the applicant fiduciary receives associated credentials and is granted access to secured digital assets.

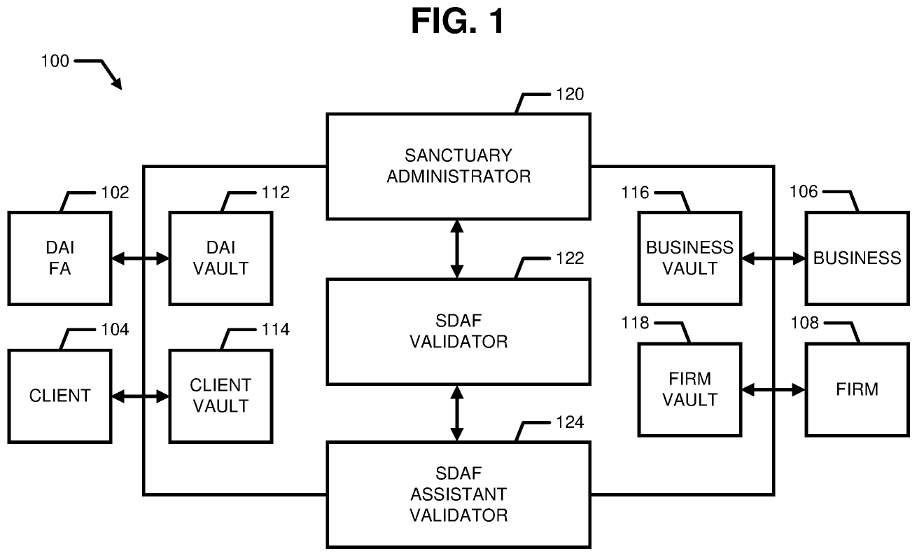

In some embodiments, the Sanctuary fiduciary authentication system comprises a Sanctuary Administrator for any fiduciary authentication system, a SDAF, a SDAFV validator, and SDAF and SDAFV assistant validator, a plurality of vaults, or a combination thereof. Referring to FIG. 1, Sanctuary Administrator 120 may also be referred to as the Sanctuary fiduciary authentication server 120 and a DAI fiduciary administrator (“FA”) 102 may also be referred to as the DAI digital-asset fiduciary authentication server 102. The specific vaults vary depending on the specific clients to the Sanctuary fiduciary authentication system. However, in various embodiments, the Sanctuary fiduciary authentication system comprises a Digital-Asset Initiative (DAI) administrator vault, a client vault, a fiduciary vault, a fiduciary firm vault, or combinations thereof. The vaults securely store digital assets. In various embodiments, the vaults employ encryption technology to protect the data and security technology to restrict access to the digital assets. Exemplary encryption technologies include DES, 3DES, AES, Blowfish, and RSA. The vaults are coupled to the respective entities needing access to those specific vaults once processed by the Sanctuary fiduciary authentication system and/or the DAI digital-asset fiduciary authentication system.

Continuing with reference to FIG. 1, Sanctuary fiduciary authentication system 100 comprises one or more vaults communicatively coupled to one or more end user vaults in accordance with embodiments of this disclosure. The vaults may comprise a DAI vault 112, a client vault 114, a client business vault 116, and a fiduciary firm vault 118 with separate individual SDAF vaults, SDAFV vaults and assistant vaults. Collectively, these vaults are referred to as the “Sanctuary individual vaults.”

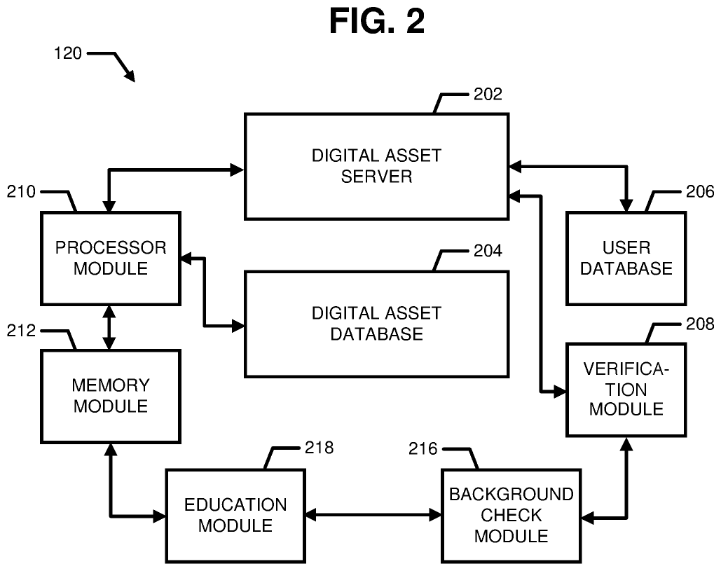

The end users may comprise a DAI fiduciary administrator (DAI FA) 102, a client 104, a client business 106, or a fiduciary firm 108 with separate individual SDAF fiduciary, SDAF Validator and SDAF assistant validators. The DAI fiduciary administrator 102 is the DAI organization that does not comprise any fiduciaries, and is communicatively coupled to a DAI administrator vault 112. In various embodiments, the DAI organization has one or more administrators that will have varying rights with respect to the Sanctuary fiduciary authentication system 100. For example, these rights may include credentialing rights regarding SDAF and SDAFV users, verification of fiduciary applicants, or rights to control the status of DAI fiduciary users within the DAI fiduciary user database 206, the DAI digital-asset fiduciary database 204 described below in FIG. 2, or a Sanctuary Fiduciary Directory within the Sanctuary fiduciary authentication system 100.

The other user vaults within the Sanctuary fiduciary authentication system 100 are similarly communicatively coupled to their respective vaults. For example, the client vault 114 is communicatively coupled to the client 104, client business 106 is communicatively coupled to the client business vault 116, and fiduciary firm 108 is communicatively coupled to the fiduciary firm vault 118. In some embodiments, firm vault 118 comprises separate individual SDAF vaults, SDAFV vaults, and assistant vaults. Each of these vaults may comprise any combination of hardware capable of providing secured access to digital assets, including but not limited to network accessible storage units, servers, or data centers.

Sanctuary Administrator 120, which may also be referred to as the Sanctuary fiduciary authentication server 120, coordinates the communication and sharing between the Sanctuary individual vaults, and also may store administrative rights between the Sanctuary individual vaults and the end users. In some embodiments, the administrative rights comprise, for example, the grant or denial of administrative rights to one or more of the Sanctuary individual vaults, communication information, or sharing information. These rights may vary depending on the types of purposes needed by the specific user and granted by the Sanctuary fiduciary authentication system 100. For example, in various embodiments, the purposes comprise a fiduciary purpose 502, a non-fiduciary purpose 504, a fiduciary corporate purpose 506, a non-fiduciary corporate purpose 508, or other purpose 510 (a DAI purpose).

Both the SDAF validator (“SDAFV”) 122 and the SDAF assistant validator 124 are communicatively coupled to at least one of the Sanctuary individual vaults. The SDAFV may have several types of rights including: 1) invite and share the rights of a SDAF with client vaults 114 and business vaults 116, 2) validate any client vaults 114 and business vaults 116 which is not a right of SDAF, and 3) become a Sanctuary Fiduciary Firm Manager which is not a right of the SDAF. The SDAFV does not have rights to validate any fiduciary or fiduciary firm as such validation will be transmitted through the fiduciary authentication system.

A SDAF (Sanctuary Digital-Asset Fiduciary), SDAFV (Sanctuary Digital-Asset Fiduciary Validator), and assistants are fiduciary users that have been verified by and received the DAI Digital Asset Fiduciary credential within the DAI digital-asset fiduciary authentication system. In some embodiments, a SDAF and SDAFV receive Sanctuary specific credentials administered by the DAI digital-asset fiduciary authentication system after verification. The SDAFV assistant 124 may help the SDAFV validator 122; however, the SDAFV validator 122 is the module that performs a validation method to grant rights to a firm's client user 104 or a client business user 106. Once a user is a SDAFV, that user may validate other client users, validate business client users, provide input regarding the SDAFV firm's administrative rights, or become a Fiduciary Firm Manager. With respect to the SDAFV assistant validator, the rights for assistants within the fiduciary authentication system 100 may be stored within this module 124 or stored at a memory module connected to the fiduciary authentication system 100.

The various vaults and the Sanctuary individual vaults may each have their own specific profiles for communicating with Sanctuary SDAFV validator or the Sanctuary SDAFV assistant validator depending on the needs for that particular relationship. For example, the Fiduciary Firm Manager vault receives communication of DAI requirements or policies for the SDAF, SDAF assistant, SDAFV validator or the SDAFV assistant validator. While one SDAFV and one SDAFV assistant validators are shown in FIG. 1, any number of SDAFV validators can be utilized depending on the number of client users, client business users, and size requirements for storing information to support the individual vaults operation.

To become a SDAF and SDAFV, users should meet specific requirements that can be set within the fiduciary authentication system. Depending on the purpose and associated rights, these requirements may vary. Furthermore, specific maintenance programs can be set that will require a refresh of requirements for each SDAF or SDAFV user. For example, for a fiduciary corporate purpose, specific licensing information may need to be confirmed, a background check passed, or an exam regarding compliance with corporate procedures successfully passed before the user is confirmed as a SDAFV with Sanctuary Fiduciary Firm Manager corporate administrative rights.

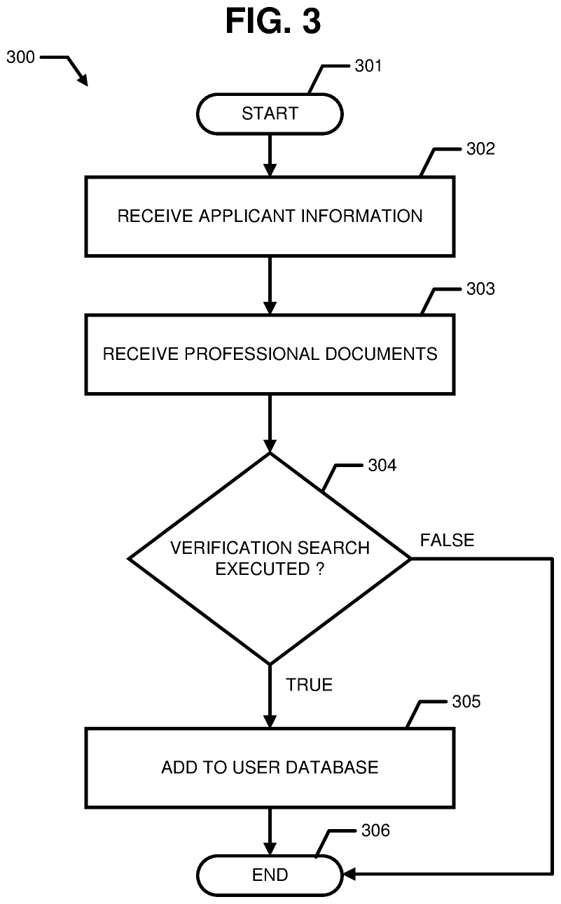

Referring to FIG. 1, the Sanctuary fiduciary authentication server 120 determines administrative rights within the Sanctuary fiduciary authentication system 100. In the Sanctuary fiduciary authentication system 100, different levels of administrative rights are granted to the users of the system. For example, the Sanctuary fiduciary authentication server 120 may grant certain super-user rights to specific fiduciary users to notify other users or administrators of the number of Sanctuary individual vaults needed at the associated company holding the account. In some embodiments, another right granted by the Sanctuary fiduciary authentication server 120 comprises the specific contact at the company who will be responsible for making payments for the account. In some embodiments, users receiving rights from the Sanctuary fiduciary authentication server 120 also have a Sanctuary digital-asset seal and/or the DAI digital-asset fiduciary seal. Such seals can be affixed to a user's website to indicate participation in the Sanctuary fiduciary authentication system and the DAI digital-asset fiduciary authentication system. In some embodiments, the Sanctuary administrators and Sanctuary Fiduciary Firm Managers are involved in notifying fiduciaries in the event of a false status of a fiduciary and moving those clients to a substitute fiduciary as described in FIG. 3.

In some embodiments, administrative rights related to fiduciary corporate purpose can be restricted to a certified validator (a Sanctuary Digital-Asset Fiduciary Validator or “SDAFV”), and once granted by the Sanctuary fiduciary authentication server 120, permit the user to communicate with the associated Sanctuary Individual Vault for that company within the Sanctuary fiduciary authentication system 100. As shown in FIG. 1 regarding the SDAF Validator module 122 and SDAF Assistant Validator module 124, rights related to a fiduciary corporate purpose may include the ability to be notified by either Sanctuary Administrators 120 through the Sanctuary fiduciary authentication system 100 or the DAI fiduciary administrator 102 through the Sanctuary fiduciary authentication system 100 about the status of a fiduciary in the DAI digital-asset fiduciary database 204 and/or the Sanctuary Digital-Asset Fiduciary (SDAF) or Sanctuary Digital-Asset Fiduciary Validator (SDAFV) directory which may be stored anywhere within the Sanctuary fiduciary authentication system 100 including, in some embodiments, the Sanctuary Administrator 120.

In some embodiments, Sanctuary fiduciary authentication server 120 grants to certain users additional rights which can be grouped as “non-fiduciary” purposes which include both non-fiduciary purpose rights 504 and non-fiduciary corporate purpose rights 508 depending on the type of clients and their associated vaults, e.g., client vault 114 or client business vault 116. In some embodiments, the non-fiduciary purpose rights are rights to own, control, and share the digital assets that are related to the specific client vault 114 or client business vault 116 including any file shared by a fiduciary through the fiduciary vaults. In some embodiments, the non-fiduciary is validated for access to a Sanctuary Individual Vault. If the clients are validated by a SDAFV, then the SDAFV was verified and credential through the fiduciary authentication system and granted a fiduciary corporate purpose right. In some embodiments, the non-fiduciary is granted rights to accept invitations to a client vault 114 or a business vault 116, invite and remove any fiduciary or fiduciary firm for access to the client's and business client's vaults, and choose another fiduciary with an invitation at any time. If a fiduciary or fiduciary company is removed by a client, then the fiduciary will lose access to that client vault 114 or client business vault 116. The non-fiduciary also may have the right to pay for more storage for personal use for upload and download.

In one embodiment, the Sanctuary fiduciary authentication server 120 may communicate with a separate DAI digital-asset fiduciary authentication server 202, which stores or has access to a digital-asset fiduciary database 204, fiduciary user database 206, verification files 208, background check files 216, and education files 218. The DAI digital-asset fiduciary authentication server 202 comprises a communicative connection to a memory module 212 which is connectively coupled to a network such as a local area network or the internet. The memory module 212 may comprise memory for storing any type of information utilized in the Sanctuary fiduciary authentication system including but not limited to a Sanctuary Fiduciary Directory, the instructions utilized in method 300, information utilized by the education module 218, or the information utilized by the background check module 216.

The DAI fiduciary user database 206 comprises a fiduciary user file for each fiduciary user. The file is created upon account creation. This fiduciary user file includes a fiduciary user identifier that will indicate which specific authentication or verification process applies to the specific type of fiduciary. The fiduciary user file stores results from the verification and credential process which may include the verification module 208, background check module 216, education module 218, or combinations thereof. The DAI digital-asset fiduciary authentication server 202 also comprises a processor module 210 which executes instructions to authenticate fiduciary users to be included in the digital-asset fiduciary database 204 and to grant access to secured digital assets. While digital-asset fiduciary database 204 is shown in FIG. 2 as a component communicatively coupled to the DAI digital-asset fiduciary authentication server 202, the digital-asset fiduciary database 204 may also be located on a network accessible storage module within system Sanctuary fiduciary authentication system 100.

The processor module 210 also provides for a DAI administrator to verify and confirm the identity of a fiduciary user, the specific type of verification method to be used is associated with the fiduciary user file in fiduciary user database 206. In some embodiments, the system comprises a verification module 208 which requires a fiduciary to identify himself/herself by providing personal information such as social security number, tax payer identification number, date of birth, phone number, address, Real ID, passport number, driver's license number, or the like. The verification module 208 can confirm the fiduciary has provided the correct identifying information. In some embodiments, the verification module is configured to receive professional license information from a fiduciary applicant. In some embodiments, the verification module is configured to connect to an online-database comprising licensure information of the profession of the fiduciary applicant. The verification module, in some embodiments, is configured to verify that the fiduciary's applicant's professional license is valid, not suspended, and/or not revoked in the relevant professional licensure database. In some embodiments, once the verification module 208 confirms the identity of the fiduciary, the verification and credential process ends unless a requirement for a background check module 216 or an education module 218 is needed. In some embodiments, completion of the verification and credential process includes verification module 208, background check module 216, education module 218, or combinations thereof. Once completed, the fiduciary applicant is verified and credentialed to receive a verification token and credential token from processor 210. This verification token and credential token is associated with the fiduciary user file in fiduciary user database 206. When a fiduciary user file in the fiduciary user database displays a “pass” or “approved” status, then the DAI digital-asset fiduciary authentication server 202 or DAI Administrator grants a DAI Digital-Asset Fiduciary (DAF) credential to the fiduciary user to allow access to secured digital assets and submits the fiduciary name to the digital-asset fiduciary database 204. In some embodiments, if an additional credential is required by a specific company such as Sanctuary, then the fiduciary name will be submitted to both the DAI digital-asset fiduciary database and the Sanctuary SDAF or SDAFV directory.

Once the fiduciary user has been verified and credentialed, and a verification token and/or credential token is added to the fiduciary user file, then the fiduciary user will be included in the digital-asset fiduciary database 204. In some embodiments, the digital-asset fiduciary database 204 may be housed within the DAI digital-asset fiduciary authentication server 202. In some embodiments, the digital-asset fiduciary database 204 comprises information related to users of a specific company such as Sanctuary and may reside in a separate company server within the Sanctuary fiduciary authentication system 100. With verification and credentialing, the fiduciary applicant associated with the fiduciary user file will be granted access to secured digital assets.

In some embodiments, the system also comprises an education module 218 as part of the verification and credential process. Upon completion, indication of fulfillment of the education requirement is submitted to the fiduciary user file. In some embodiments, after, or in conjunction with, verifying that a fiduciary applicant is in good standing with the relevant state board or credentialing authority, education module 218 provides a curriculum to the fiduciary user. In some embodiments, the curriculum relates to best practices and procedures for safeguarding digital assets now and in the future, including after a person's death. In some embodiments, the fiduciary applicant will complete and pass an examination regarding a code of ethics and/or conduct standards. In some embodiments, the curriculum comprises material related to the fiduciary's profession and related obligations for protecting personal information. In an exemplary embodiment where the fiduciary is an attorney, the curriculum relates rules of professional conduct (e.g., the ABA Model Rules or a local adoption). In some embodiments where the fiduciary is an accountant, the curriculum relates to a code of professional conduct (e.g., the AICPA Code of Professional Conduct). In some embodiments where the fiduciary is a healthcare professional, the curriculum relates to the privacy and security standards set forth by the Health Insurance Portability and Accountability Act (“HIPAA”). In some embodiments, the education module educates the fiduciary in using a specific company fiduciary tool such as the Sanctuary Individual Vault prior to the DAI digital-asset fiduciary authentication server or administrator 202 granting access to the Sanctuary individual vaults and any digital assets in the vaults.

In some embodiments, the fiduciary will complete and pass an examination after the education module provides the curriculum. In certain other embodiments, the education module ceases providing the curriculum and then provides an examination to the fiduciary. In some embodiments, if the fiduciary passes the examination, then the education module 218 notifies the DAI digital-asset fiduciary authentication server 202 and the system submits the passed credential to the fiduciary user file and updates the user's status as a Digital-Asset Fiduciary (DAF) or any other credential requirement like a validated fiduciary for the Sanctuary Individual Vaults. In some embodiments, if the fiduciary applicant does not pass the examination, then the education module 218 notifies the DAI digital-asset fiduciary authentication server 202 and the system submits the failed credential status to the fiduciary user file. In such instances, the status of the user shows as failed as a validated fiduciary for the DAI DAF or the Sanctuary Digital-Asset Vault. In some embodiments, the education module requires that the fiduciary applicant get at least 60%, 70%, 80%, 90%, 95%, or 100% of the questions on the examination correct in order to confirm that the fiduciary applicant passed the examination.

In some embodiments, the DAI digital-asset fiduciary authentication server 202 also comprises background check module 218 which is part of the verification and credential process. In some embodiments, the background check module is administered in addition to the education module. Background check module 218 requests and then receives permission by the fiduciary to certain information from the fiduciary applicant, such as criminal record, social security number, birth date, address, Real ID, passport number, or the like. Some of this information may be in an attestation format that requires an esignature or signature by the fiduciary applicant. In some embodiments, the background check module 216 is part of the processor module 210. In some embodiments, the background check module 216 receives the identifying information from the processor module 210. In some embodiments, after receiving the information, the background check module 216 researches the fiduciary applicant's background to determine whether the fiduciary applicant has a record of crimes or offenses, news articles, good or bad credit, any complaints or suspensions related to the fiduciary's professional licensure, and the like. In some embodiments, the background check module 216 connects with a third-party background check service to perform the background check and conduct research into the fiduciary applicant. In some embodiments, fiduciaries are re-evaluated periodically. Such re-evaluation can include an audit by DAI to verify the fiduciaries' actions in keeping a client's digital-assets and personal information secure. In some embodiments, this audit is conducted using a blockchain. In some embodiments, the background check module is used periodically as part of an audit of a fiduciary's credentialed status.

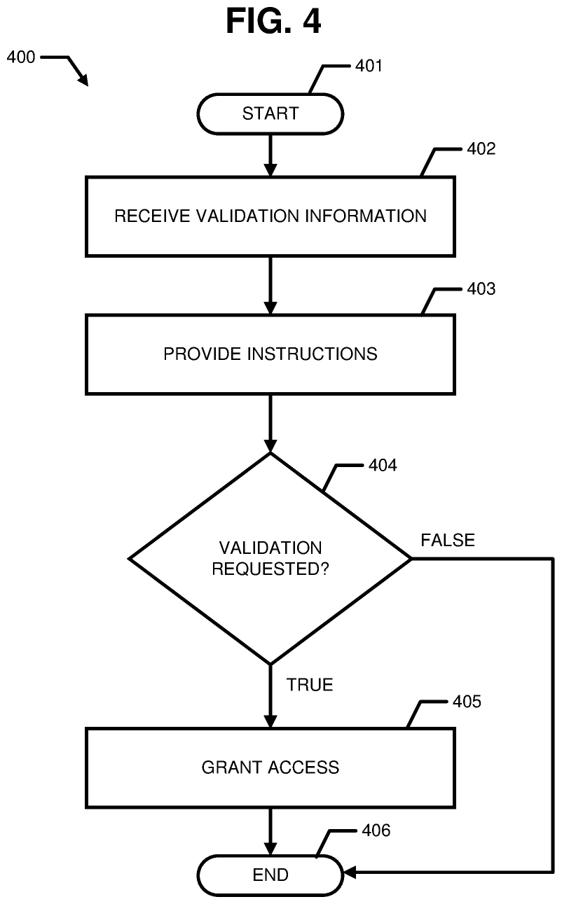

FIG. 3 is a flow diagram illustrating an embodiment of Sanctuary fiduciary validation method 300 for validating a fiduciary request in Sanctuary in accordance with an embodiment of this disclosure. While the Sanctuary fiduciary validation method 300 is described, those of ordinary skill in the art will appreciate that a number of processes could be substituted here within the spirit and scope of the invention. The Sanctuary Fiduciary Validation Process is utilized to validate a fiduciary. In some embodiments, the Sanctuary Fiduciary Validation Process comprises a combination of the Sanctuary fiduciary validation method 300 in FIG. 3 and the DAI fiduciary verification and credential method 400 in FIG. 4. The Sanctuary Fiduciary Validation Process validates fiduciary applicants before Sanctuary Administrator 120 grants certain rights through the Sanctuary fiduciary authentication system 100. Once completed, the fiduciary is added to the DAI digital-asset fiduciary database 204 and/or the Sanctuary fiduciary directory, and can access secure digital assets in the vaults. Validated fiduciaries can also use the Sanctuary Digital-asset Fiduciary Seal(s)—such as SDAF and SDAFV—to promote or confirm their validation.

The Sanctuary fiduciary validation method 300 is one part of the Sanctuary fiduciary validation process. The method begins with an invitation process at Start 301 which is an invitation from the Sanctuary system. Before a fiduciary applicant can request to be validated in Sanctuary 304, the applicant is invited by a Sanctuary Administrator 120 if requesting fiduciary corporate purpose rights or the Fiduciary Firm Manager with fiduciary corporate purpose rights. Once the fiduciary applicant accepts the invitation 301, the fiduciary applicant will complete the Sanctuary personal profile 302 and provide professional licenses 303. In some embodiments, the personal profile and/or professional licenses cannot be changed once viewed by an DIA fiduciary administrator. In some embodiments, this information is encrypted, tracked, and validated via the blockchain. In certain embodiments, if any information related to the fiduciary needs to be changed or updated, then the Sanctuary Fiduciary Validation Process starts over.

During the Sanctuary Fiduciary Validation Process the fiduciary's status will show “pending” which means the fiduciary does not have access to vaults or secured digital access. In some embodiments, the fiduciary applicant and the Sanctuary Fiduciary Firm Manager are notified by DAI digital-asset fiduciary authentication system 202 and the Sanctuary fiduciary authentication system 100 prior to the fiduciary receiving approved status. In other embodiments, a vault is purchased by the Sanctuary Fiduciary Firm Manager with fiduciary corporate rights 506 prior to the fiduciary receiving approved status. In some embodiments, initial applicant information comprises payment information, a completed background check, and/or a signed application received from an applicant beneficiary. In some embodiments, the professional license and certification documents (“professional documents”) vary depending on the type of fiduciary. Such documents may comprise a copy of a license held by the fiduciary applicant, a bar number, or other type of license number held by the fiduciary applicant.

At step 304, a validation request is made by the fiduciary applicant in Sanctuary. The validation request 304 is received by the DAI digital-asset fiduciary authentication server from a notification through the DAI administrators vault within the Sanctuary fiduciary authentication system. Subsequently, in some embodiments, two processes begin after fiduciary validation request 304 before moving to step 305. The first process continues with the fiduciary applicant being linked to the DAI fiduciary verification and credential method 400 in FIG. 4 for further application instructions before the process in FIG. 3 can be completed. The second process occurs when the DAI administrator begins to verify the fiduciary applicant and creates a fiduciary file for the fiduciary user database. Depending on the type of fiduciary, this verification process varies. If the fiduciary applicant is a CPA, the State Board of Accountancy to which the fiduciary applicant claims to be licensed may be searched to confirm or deny licensure of the fiduciary applicant. In an embodiment wherein the fiduciary applicant is an attorney, the State Bar to which the fiduciary applicant claims to be a member may be searched in that bar's online member directory. For RIA or CFP, the fiduciary applicant may be searched in databases at SEC or comparable entities to confirm a status of good standing. If a fiduciary is a healthcare professional, the fiduciary applicant may be searched in databases the provide medical licensure.

In FIG. 4, the DAI verification and credential method 400 is completed by the DAI, then the Sanctuary fiduciary validation process comes back to the Sanctuary fiduciary validation method 300 in FIG. 3 to complete the determination of the validation request 304. If the verification search at step 404 returns a false (a “false status”), the DAI fiduciary verification process is unable to confirm the fiduciary applicant and does not grant the fiduciary applicant access to the system at Sanctuary validation request 304. If the verification search at step 404 returns a positive or approved status, the DAI fiduciary verification process has confirmed the fiduciary applicant as a “verified fiduciary” and can be validated in Sanctuary 305 as such by the DAI administrator in Sanctuary granting the fiduciary access to secure digital-assets. The fiduciary user can be added to both the DAI digital-asset fiduciary database 204 and the Sanctuary fiduciary directory at step 306. The fiduciary user can begin to use the Sanctuary Digital-Asset Fiduciary Seal 307 and the DAI Digital-Asset Fiduciary (DAF) Credential.

The validation method 300 may be executed at various times depending on different embodiments of this disclosure. For example, the validation process may be performed upon signing up a new fiduciary applicant who wants to access the Sanctuary fiduciary authentication system and upon a regularly occurring interval afterwards (daily, monthly, yearly, etc.). Furthermore, access to the Sanctuary fiduciary authentication system may be disallowed during a time period in the event a verified fiduciary is suspended from a licensing authority or otherwise should not access the system for a specific period of time.

In some cases, a verified fiduciary or fiduciary applicant may lose access. For example, a fiduciary may have a license suspended, and/or may have conditions that need to be fulfilled before the license will be reinstated. In some embodiments, the system automatically detects the loss of license through regular checks on the requisite licensing database. In some embodiments, a condition of a fiduciary's access is a requirement to notify the system of any loss or suspension of professional licensure. In such instances, the fiduciary applicant will be flagged as a “nonverified fiduciary” in the fiduciary user database 206 until such time that the licensing authority reports otherwise. Nonverified fiduciaries are removed from, or marked as nonverified in, the digital-asset fiduciary database 204 and/or the Sanctuary Fiduciary Directory. In the event of a verified fiduciary becoming nonverified, the nonverified fiduciary's Sanctuary Fiduciary Firm manager may be notified and/or clients may be notified of the change and/or being provided with a proposed replacement fiduciary. In some embodiments, an external entity may be queried for a replacement fiduciary in this situation.

FIG. 4 is a flow diagram illustrating the DAI verification and credential process in accordance with an embodiment of this disclosure. The DAI verification and credential process is utilized to allow an end user to access a Sanctuary digital access vault (e.g., a Sanctuary vaults illustrated in FIG. 1) as a fiduciary applicant. The verification and credential process may be used alone, in combination with Sanctuary validation process 300, or in combination with another process to determine the appropriateness of granting access to secured digital assets to a fiduciary applicant according to relevant criteria.

In the DAI verification and credential method 400, the fiduciary applicant completes the Sanctuary fiduciary validation process. At this stage, the fiduciary applicant provides specific information at step 402 upon linking from Sanctuary or signing into DAI for access at step 401 to the DAI fiduciary verification and credential method 400. The specific information requested from the fiduciary applicant and used in the verification process (“verification information”) varies depending on the type of fiduciary applicant and the type of fiduciary relationship. In one embodiment, a fiduciary applicant may be requested to provide a social security number, any other personal identification number, a self-attestation statement regarding identity or intended purposes by using the Sanctuary fiduciary authentication system, or other identifying information described herein. An application fee or other fees may be requested at this time.

The fiduciary applicant is provided instructions about handling of personal information at step 403. These instructions can be crafted based on the type of environment housing the Sanctuary fiduciary authentication system. In some embodiments, instructions may contain requirements for encryption, document retention rules, or other policies regarding the handling of sensitive information. At this step the fiduciary applicant may also be requested to take educational curriculum and exams that require a passing rate. If the applicant is requesting to become a SDAF or a SDAFV, then the appropriate curriculum will be requested with the appropriate fees associated with that curriculum.

At step 404, DAI administrator verifies the fiduciary once the fiduciary applicant has completed the verification steps. In some embodiments, the verification process comprises verifying the identity of the fiduciary applicant, conducting online background checks, checking with online member directories or databases, electronically querying third parties, or a combination thereof. In some embodiments, the verification process also comprises reviewing the verification steps within DAI to ensure the process is complete.

At step 406, upon being validated, the new certified fiduciary is granted a verification token and is entitled to be included in the DAI digital-asset fiduciary database 204. Additionally, the fiduciary may be added to the Sanctuary fiduciary directory which may be stored in memory module 212. This access is granted by associating a verification token with the fiduciary user file associated with the fiduciary applicant in the DAI fiduciary user database 206. If the verification request at step 404 returns with a false result, the method ends at step 406 without submitting the fiduciary applicant to the DAI digital-asset fiduciary database or the Sanctuary fiduciary directory or granting the fiduciary applicant access to a Sanctuary vault within the Sanctuary fiduciary authentication system.

This DAI verification and credential process 400 may be performed at multiple times in the operation of the fiduciary authentication system. For example, a DAI verification and credential process can be performed when a user has initially joined, and at regular intervals after joining to confirm that the user's status should remain unchanged in the system. For SDAF and SDAFV users, this verification process may be used when upgrading the user to one of those statuses, and also, may be performed at more frequent intervals to ensure integrity of those users within the Sanctuary fiduciary authentication system 100. During any of the multiple verification processes of an already verified fiduciary who is in the DAI digital-asset fiduciary database 204 is updated with verification dates and results. If the verification step 404 returns a false result, then a special investigation determines: i) if the fiduciary needs removed from the both the DAI digital-asset fiduciary database 204 and the Sanctuary fiduciary directory; if the fiduciary should be refused access to the associated Sanctuary Individual Vault; and if a notice should be sent to notify the fiduciary's Sanctuary Fiduciary Firm. A false result can also be returned after special investigation if the Fiduciary Firm Manager or a regulatory body communicates with DAI.

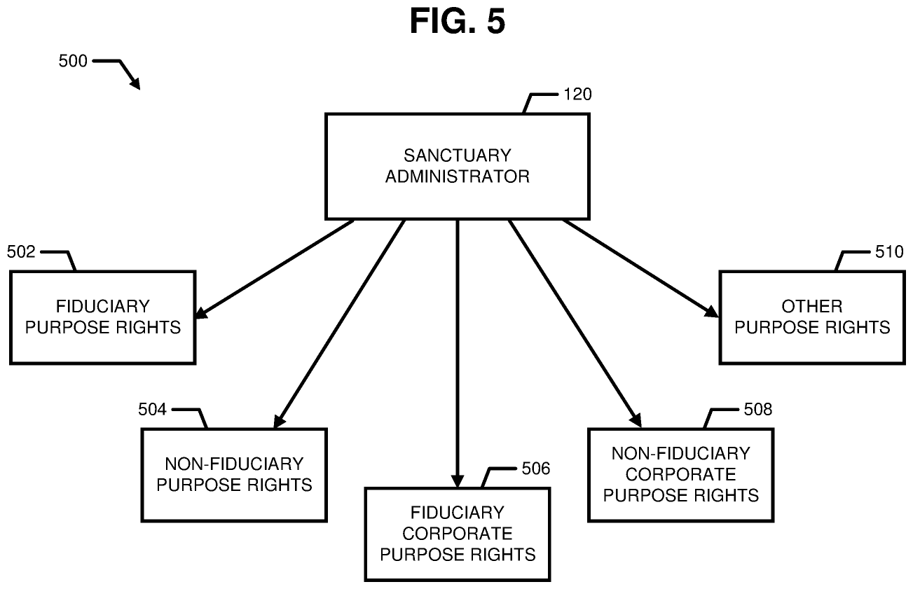

FIG. 5 illustrates the various types of rights granted by the Sanctuary Administrator 120 in the Sanctuary fiduciary authentication system 100. In the Sanctuary fiduciary authentication system 100, different levels of administrative rights may be granted to certain users of the system which are called “administrators” or “Sanctuary administrators” or “Sanctuary Fiduciary Firm Managers”. These rights may be stored within the Sanctuary fiduciary authentication system 100.

For example, certain users may be administrators with certain super-user rights to notify other users or administrators of the number of Sanctuary individual vaults needed at the associated company holding the account, or the specific contact at the company who will be responsible for making payments for the account. These administrators may also have a digital-asset seal for the individual or company website to display indicating participation in the Sanctuary fiduciary authentication program. The administrators may also be involved in notifying fiduciaries in the event of a false status of a fiduciary and moving those clients to a substitute fiduciary as described in FIG. 3. The specific aforementioned rights are included within “fiduciary purpose rights” 502, and as such, comprise a special set of rights which can be granted to specific administrators depending on circumstances or business needs from a Sanctuary fiduciary authentication system client. Further, these fiduciary purpose rights can be restricted to a certified validator such as a SDAFV, and once granted, permit the administrator to communicate with the associated Sanctuary Individual Vault for that company within the Sanctuary fiduciary authentication system.

In some embodiments, the system grants certain rights to certain administrators which can be grouped as non-fiduciary corporate rights 508. In some embodiments, such rights are granted to client business users. For example, non-fiduciary corporate purposes may comprise information relating to the number of administrators at a non-fiduciary company, the number of Sanctuary individual vaults needed at the company level, and the name of the contact at the company responsible for making payments.

Multiple administrators in the end users (DAI FA 102, the client 104, client business 106, or fiduciary firm 108) may be granted access to fiduciary, non-fiduciary or other rights by the Sanctuary Administrator 120 to the Sanctuary individual vaults. Furthermore, the Sanctuary Administrator 120 may also provide for communication and sharing through each associated Sanctuary individual vault to the relevant fiduciary company, non-fiduciary company, or other company (including DAI). In some embodiments, Sanctuary administrators do not have communication and sharing rights with SDAF or SDAFV, unless the SDAFV has or is requesting fiduciary corporate rights 506 and is a Sanctuary Fiduciary Firm Manager.

In some embodiments, administrator(s) in the Sanctuary fiduciary authentication system 100 have administrative rights to approve fiduciaries certified as a SDAFV, i.e., that have “SDAFV status” as administrator(s) for fiduciary corporate purpose rights 506. SDAFV administrators that have received fiduciary corporate purpose rights 506 have rights to communicate and share with the Sanctuary fiduciary authentication system 100 through the Sanctuary Administrator 120 various information, including: the number of Sanctuary individual vaults needed at both the company level and client level, who will be responsible for making payments; a digital-asset seal for marketing purposes, listing of the company's fiduciaries' status in the SDAF or SDAFV directory as applicable; credentialing letters; audits, and verifying clients and business clients as described in FIG. 4 and a mandatory submission of their verification identifier with fiduciary identifier into the Sanctuary client database verifying that only one client identifier is associated with only one vault (the same rights as an SDAFV).

In some embodiments, administrator(s) in the Sanctuary fiduciary authentication system 100 have administrative rights to approve administrator(s) for non-fiduciary corporate purposes 508 to communicate and share with Sanctuary fiduciary authentication system 100 through the Sanctuary individual vaults regarding various information, including: the number of administrators; number of vaults; the contact for making payments; and a digital-asset seal for marketing purposes. A client business 106 with non-fiduciary purpose rights 504 is an example of who would need a non-fiduciary corporate purpose 508. Furthermore, rights granted may comprise the right to send or receive new/updates of SDAF and SDAFV credentialing, verification, the status of the SDAF and SDAFV in the fiduciary user databases, and instructions regarding credentialing letters and clients for a fiduciary SDAF or SDAFV false status as described in FIG. 3.

In some embodiments, Administrative Rights for the fiduciary corporate purposes 506 regarding the Sanctuary individual vaults allow for assigning and inviting assistants for a SDAF or SDAFV within the company. Rights for fiduciary corporate purposes 506 also provide for communication and sharing to Sanctuary Administrators 120, the DAI, and the company's SDAF, SDAFV, and assistants. Exemplary administrative rights for fiduciary corporate purposes 506 comprise: assigning assistant roles to help a SDAF and SDAFV communicate and share with the SDAF and SDAFV clients; paying for clients vaults; paying for assistant vaults (i.e., one or more Sanctuary individual vaults to support an assistant); inviting SDAF and SDAFV within the company and paying for their vaults; and rights to provide notifications to a SDAF or SDAFV and their assistant(s) through the Sanctuary Digital-Asset Vault regarding other company matters. Administrative rights for fiduciary corporate purposes 506 are utilized to reassign client vaults within the company to a new SDAF or SDAFV when access is removed for a SDAF or SDAFV from their respective vault when notified of SDAF or SDAFV no longer with company or notified by the DAI of any fiduciary SDAF or SDAFV showing a false status as described in FIG. 3 and to be notified of the SDAF and SDAFV status in the fiduciary databases. Administrative Rights for the fiduciary corporate purposes 506 is to grant use of a digital-asset seal for marketing purposes and provide access to the Sanctuary individual vaults during a DAI audit. Administrative Rights to verify clients and business clients and a mandatory submission of their verification identifier with fiduciary identifier into the Sanctuary client database verifying that only one client identifier is associated with only one vault (the same rights as an SDAFV).

Rights relating to other purposes may also be provided by the Sanctuary Administrator 120. For example, an administrator at another account not associated with a fiduciary within the Sanctuary fiduciary authentication system, including without limitation a DAI, may be provided rights to access the number of vaults and share the contact responsible for making payments. Additionally, rights relating to other purposes for the DAI may comprise audit information, credentialing information, status in the fiduciary user database 206 and the digital-asset fiduciary database, including any fiduciaries showing a false status as described in FIG. 3, or any other requested or relevant corporate matters.

Besides having the right to receive information, the rights in FIG. 5 may comprise the right to transmit information. For example, DAI administrator(s) with other purpose rights may notify other administrator(s) regarding credentialing letters and clients fiduciaries with a false status. A DAI administrator(s) in this example embodiment may notify other administrator(s) through the Sanctuary fiduciary authentication system 100 of yearly audits by the DAI which includes access to the blockchain of information being stored, shared, deleted, granting access, and more.

### EQUIVALENTS

It is to be understood that the foregoing description is intended to illustrate and not limit the scope of the invention, which is defined by the scope of the appended claims. Those skilled in the art will recognize, or be able to ascertain, using no more than routine experimentation, numerous equivalents to the specific embodiments described specifically in this disclosure. Such equivalents, and other aspects, advantages, and modifications are within the scope of the following claims.

1. A computer-implemented method for providing a fiduciary with a digital token configured to allow access to a secured digital asset, the method comprising the steps of:
receiving, at a server operably connected to a network, an application comprising information that identifies an applicant and indicates the applicant's profession;
receiving, at the server, professional license information of the applicant;
creating, at the server, a file for the applicant;
searching an online database comprising licensure information of practitioners of the profession of the applicant;
locating licensure information of the applicant in the database;
verifying that the applicant's professional license is valid;
adding the applicant to a fiduciary database connected to the server, wherein the fiduciary database comprises a plurality of names of individuals that have been verified as having a valid professional license; and
adding a digital token to the file of the applicant, wherein the digital token is configured to allow access to a digital asset stored in a digital vault.

2. The method of claim 1, further comprising
providing to the applicant, over a network, a curriculum; and
certifying that the curriculum has been sent to the applicant.

3. The method of claim 2, further comprising
administering an on-line examination to the applicant, wherein the examination comprises questions related to the curriculum; and
certifying that a predetermined percentage of the answers received from the applicant are correct.

4. The method of claim 3, wherein the curriculum comprises material related to practices for protecting digital assets.

5. The method of claim 3, wherein the curriculum comprises material related to ethics or rules of professional responsibility related to the profession of the applicant.

6. The method of claim 1, further comprising receiving, at the server, an agreement from the applicant indicating the applicant's assent to the application process.

7. The method of claim 1, further comprising receiving, at the server, an attestation from the applicant, wherein the attestation indicates that the applicant agrees to terms of service associated with use of the digital token.

8. The method of claim 1, further comprising performing an online background check of the applicant.

9. The method of claim 8, wherein the background check comprises searching for information related to one or more of the applicant's criminal background, credit score, bankruptcy history, professional license history, aliases, education history, or combinations thereof.

10. The method of claim 1, further comprising notifying the applicant that the applicant has been granted a digital token.

11. A computer-implemented method for credentialing a fiduciary to allow the fiduciary to access one or more digital assets stored in a vault, the method comprising:
receiving, at a server operably connected to a network, an application comprising information that identifies an applicant and indicates the applicant's profession;
receiving, at the server, professional license information of the applicant;
creating, at the server, a file for the applicant;
searching an online database comprising licensure information of practitioners of the profession of the applicant;
locating licensure information of the applicant in the database;
verifying that the applicant's professional license is valid; and
issuing a credential to the fiduciary, whereby the credential allows the fiduciary to access to one or more digital assets stored in a digital vault.

12. A system configured to grant to an authenticated fiduciary access to one or more digital assets stored in a digital vault, the method comprising:
a server operably connected to a network and configured to process applications for authentication,
a memory module configured to store information of an application of a fiduciary and professional licensure information of the fiduciary, wherein the application requests authentication;
a verification module configured to determine the status of a professional license of the fiduciary;
a background check module configured to perform research into the background of the fiduciary;
an education module configured to send a curriculum to the fiduciary applicant, wherein the curriculum is configured to be viewed on a screen;
a fiduciary user database configured to store a file of an authenticated fiduciary and a digital token associated with the authenticated fiduciary; and
a processor module configured to add the fiduciary to the fiduciary user database and to associate a digital token with the fiduciary when the verification module, the background check module, the education module, or a combination thereof submit confirmation of authentication to the processor,
wherein the digital token is configured to allow the authenticated fiduciary to access one or more digital assets stored in a digital vault; and
wherein the server, verification module, background check module, education module, fiduciary user database, and processor module are communicatively coupled.

13.-29. (canceled)
